(19) United States
(12) Patent Application Publication
(10) Pub. No.: US 2021/0342243 A1
(43) Pub. Date: Nov. 4, 2021

(54) SYSTEMS AND METHODS FOR SYSTEM POWER CAPPING BASED ON COMPONENT TEMPERATURE MARGINS

(71) Applicant: Dell Products L.P., Round Rock, TX (US)

(72) Inventors: Hasnain SHABBIR, Round Rock, TX (US); Carlos G. HENRY, Round Rock, TX (US)

(73) Assignee: Dell Products L.P., Round Rock, TX (US)

(21) Appl. No.: 16/864,633

(22) Filed: May 1, 2020

(51) Int. Cl. G06F 11/30; G06F 11/32; G06F 11/07

(52) U.S. Cl. CPC G06F 11/3058; G06F 11/3024; G06F 11/0775; G06F 11/327; G06F 11/3075

(57) ABSTRACT

A closed-loop control system may include an integrator configured to, based on an error between a setpoint temperature and a measured temperature, determine an integrated error indicative of a time-based integral of the error, a proportional-integral controller configured to, based on the integrated error and the error, generate a proportional-integral output driving signal, and control logic configured to control power consumption of a component based on the proportional-integral output driving signal.

### TECHNICAL FIELD

The present disclosure relates in general to information handling systems, and more particularly to providing closed-loop power capping of information handling system components based on component temperature margins.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As processors, graphics cards, random access memory (RAM) and other components in information handling systems have increased in clock speed and power consumption, the amount of heat produced by such components as a side-effect of normal operation has also increased. Often, the temperatures of these components need to be kept within a reasonable range to prevent overheating, instability, malfunction and damage leading to a shortened component lifespan. Accordingly, air movers (e.g., cooling fans and blowers) have often been used in information handling systems to cool information handling systems and their components.

Temperature control in an information handling system with air movers often involves use of a closed-loop feedback system that alters air mover speed in response to a sensed temperature in the information handling system. In addition, existing approaches may utilize power capping (e.g., through throttling performance) of a processor and/or other components of an information handling system to prevent overheating of the processor in transient conditions before air mover speeds are able to catch up to cooling demands. However, traditional power capping approaches are often a manual process wherein each supporting processor in the information handling system platform must be tested and then static power capping values may be defined for each platform and each processor bin. The development work required to implement this approach is extensive due to the static values that are defined, and the power capping defined may nonetheless be sub-optimal (e.g., too much or too little power capping). Thus, approaches to improving power capping of components in an information handling system are desired.

### SUMMARY

In accordance with the teachings of the present disclosure, the disadvantages and problems associated with power capping of components in an information handling system may be substantially reduced or eliminated.

In accordance with embodiments of the present disclosure, a closed-loop control system may include an integrator configured to, based on an error between a setpoint temperature and a measured temperature, determine an integrated error indicative of a time-based integral of the error, a proportional-integral controller configured to, based on the integrated error and the error, generate a proportional-integral output driving signal, and control logic configured to control power consumption of a component based on the proportional-integral output driving signal.

In accordance with these and other embodiments of the present disclosure, a method may include based on an error between a setpoint temperature and a measured temperature, determining an integrated error indicative of a time-based integral of the error; based on the integrated error and the error, generating a proportional-integral output driving signal; and controlling power consumption of a component based on the proportional-integral output driving signal.

In accordance with these and other embodiments of the present disclosure, an information handling system may include an information handling resource and a closed-loop thermal control system comprising an integrator configured to, based on an error between a setpoint temperature and a measured temperature, determine an integrated error indicative of a time-based integral of the error, a proportional-integral controller configured to, based on the integrated error and the error, generate a proportional-integral output driving signal, and control logic configured to control power consumption of the information handling resource based on the proportional-integral output driving signal.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to: based on an error between a setpoint temperature and a measured temperature, determine an integrated error indicative of a time-based integral of the error; based on the integrated error and the error, generate a proportional-integral output driving signal; and control power consumption of a component based on the proportional-integral output driving signal.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of selected components of an example thermal control system for controlling power capping based on component temperature margins, in accordance with embodiments of the present disclosure;

FIG. 3 illustrates an example lookup table for generating a proportional-integral controller gain based on a polling rate and temperature rate of change, in accordance with embodiments of the present disclosure; and

FIG. 4 illustrates a flow chart of an example method for power capping based on component temperature margins, in accordance with embodiments of the present disclosure.

### DETAILED DESCRIPTION

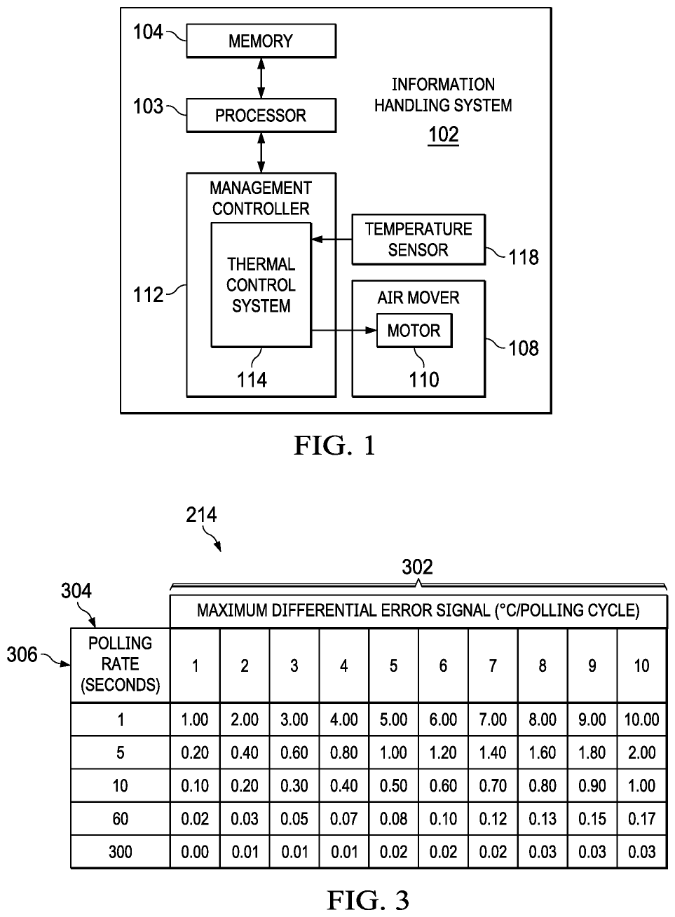

Preferred embodiments and their advantages are best understood by reference to FIGS. 1 through 4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, buses, memories, I/O devices and/or interfaces, storage resources, network interfaces, motherboards, integrated circuit packages, electro-mechanical devices (e.g., air movers), displays, and power supplies.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data. As shown in FIG. 1, information handling system 102 may comprise a processor 103, a memory 104, an air mover 108, a management controller 112, and a temperature sensor 118.

Processor 103 may comprise any system, device, or apparatus operable to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may comprise any system, device, or apparatus operable to retain program instructions or data for a period of time. Memory 104 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 102 is turned off.

Air mover 108 may include any mechanical or electro-mechanical system, apparatus, or device operable to move air and/or other gases in order to cool information handling resources of information handling system 102. In some embodiments, air mover 108 may comprise a fan (e.g., a rotating arrangement of vanes or blades which act on the air). In other embodiments, air mover 108 may comprise a blower (e.g., a centrifugal fan that employs rotating impellers to accelerate air received at its intake and change the direction of the airflow). In these and other embodiments, rotating and other moving components of air mover 108 may be driven by a motor 110. The rotational speed of motor 110 may be controlled by an air mover control signal (e.g., a pulse-width modulation signal) communicated from thermal control system 114 of management controller 112. In operation, air mover 108 may cool information handling resources of information handling system 102 by drawing cool air into an enclosure housing the information handling resources from outside the chassis, expel warm air from inside the enclosure to the outside of such enclosure, and/or move air across one or more heat sinks (not explicitly shown) internal to the enclosure to cool one or more information handling resources.

Management controller 112 may comprise any system, device, or apparatus configured to facilitate management and/or control of information handling system 102 and/or one or more of its component information handling resources. Management controller 112 may be configured to issue commands and/or other signals to manage and/or control information handling system 102 and/or its information handling resources. Management controller 112 may comprise a microprocessor, microcontroller, DSP, ASIC, field programmable gate array (“FPGA”), EEPROM, or any combination thereof. Management controller 112 also may be configured to provide out-of-band management facilities for management of information handling system 102. Such management may be made by management controller 112 even if information handling system 102 is powered off or powered to a standby state. In certain embodiments, management controller 112 may include or may be an integral part of a baseboard management controller (BMC), a remote access controller (e.g., a Dell Remote Access Controller or Integrated Dell Remote Access Controller), or an enclosure controller. In other embodiments, management controller 112 may include or may be an integral part of a chassis management controller (CMC).

As shown in FIG. 1, management controller 112 may include a thermal control system 114. Thermal control system 114 may include any system, device, or apparatus configured to receive one or more signals indicative of one or more temperatures within information handling system 102 (e.g., one or more signals from one or more temperature sensors 118), and based on such signals, calculate an air mover driving signal (e.g., a pulse-width modulation signal) to maintain an appropriate level of cooling, increase cooling, or decrease cooling, as appropriate, and communicate such air mover driving signal to air mover 108. Thermal control for air mover 108 by thermal control system 114 may be performed in any suitable manner, for example, as described in U.S. Pat. No. 10,146,190 entitled “Systems and Methods for Providing Controller Response Stability in a Closed-Loop System.”

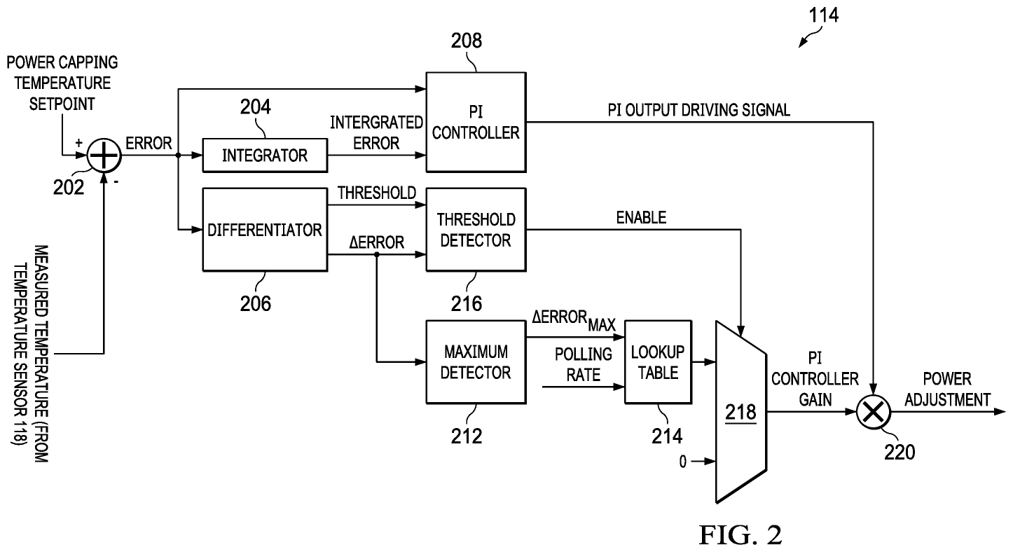

In addition, thermal control system 114 may also be configured to, in order to prevent components (e.g., processor 103) of information handling system 102 from overheating when air mover 108 is insufficient to provide adequate cooling, cause power capping or throttling of components to reduce heat generated by such components (e.g., until such time as air mover 108 is able to provide adequate cooling without power capping). The power capping functionality of thermal control system 114 is described in greater detail below with respect to FIG. 2.

In some embodiments, thermal control system 114 may include a program of instructions (e.g., software, firmware) configured to, when executed by a processor or controller integral to management controller 112, carry out the functionality of thermal control system 114.

A temperature sensor 118 may be any system, device, or apparatus (e.g., a thermometer, thermistor, etc.) configured to communicate a signal to thermal control system 114 indicative of a temperature within information handling system 102.

In addition to processor 103, memory 104, air mover 108, management controller 112, and temperature sensor 118, information handling system 102 may include one or more other information handling resources. In addition, for the sake of clarity and exposition of the present disclosure, FIG. 1 depicts only one air mover 108 and temperature sensor 118. In embodiments of the present disclosure, information handling system 102 may include any number of air movers 108 and temperature sensors 118.

FIG. 2 illustrates a block diagram of selected components of an example thermal control system 114 for controlling power capping based on component temperature margins, in accordance with embodiments of the present disclosure. As shown in FIG. 2, thermal control system 114 may include a summer 202, an integrator 204, a differentiator 206, a proportional-integral (PI) controller 208, a maximum detector 212, a lookup table 214, a threshold detector 216, a multiplexer 218, and a gain element 220. Such components of thermal control system 114 may be implemented in hardware, software, firmware, or any combination thereof.

Summer 202 may calculate an error between a temperature setpoint (e.g., representing a maximum operating temperature) and a measured temperature (e.g., as indicated from a signal communicated from temperature sensor 118) to generate an error signal which may be communicated to other components of thermal control system 114.

Integrator 204 may comprise any system, device, or apparatus configured to, based on the error signal generated by summer 202, generate an integrated error signal indicative of (e.g., equal to or approximating) a time-based integral of the error signal. Integrator 204 may be implemented in any suitable manner either now and/or in the future known in the art, and such implementation is beyond the scope of this disclosure.

Differentiator 206 may comprise any system, device, or apparatus configured to, based on the error signal generated by summer 202, generate a differential error signal ΔERROR indicative of (e.g., equal to or approximating) a time derivative of the error signal. For example, in some embodiments, differential error signal ΔERROR may be equal to a difference between the respective error signal generated from the two most recent polled temperature readings from temperature sensor 118. Differentiator 206 may be implemented in any suitable manner either now and/or in the future known in the art, and such implementation is beyond the scope of this disclosure.

PI controller 208 may include any system, device, or apparatus configured to, based on the error signal generated by summer 202 and the integrated error signal generated by integrator 204, generate a PI output driving signal using proportional-integral control, as is now known and/or as may in the future be known in the art. PI controller 208 may be implemented in any suitable manner either now and/or in the future known in the art, and such implementation is beyond the scope of this disclosure. For example, in some embodiments, PI controller 208 may comprise a fixed controller. In other embodiments, PI controller 208 may comprise a non-linear and/or adaptive controller. In these and other embodiments, PI controller 208 may comprise a fuzzy logic controller.

Maximum detector 212 may include any system, device, or apparatus configured to, based on the differential error signal ΔERROR generated by differentiator 206, detect a maximum differential error signal ΔERROR_{MAX} occurring during any suitable period of time (e.g., during a previous number of polling cycles of temperature sensor 118, since powering on of information handling system 102, etc.). Maximum detector 212 may also store such maximum differential error signal ΔERROR_{MAX} (e.g., in a computer-readable medium integral or otherwise accessible to maximum detector 212), and output such maximum differential error signal ΔERROR_{MAX}.

Lookup table 214 may include any suitable table, map, database, or other data structure integral or otherwise accessible to thermal control system 114 (e.g., stored in computer-readable media integral to or otherwise accessible to management controller 112) that includes a plurality of entries, wherein each entry sets forth a PI controller gain which is indexed by a polling rate of a measured temperature (e.g., measured by temperature sensor 118) and a maximum rate of change of the measured temperature between polling events of the measured temperature (e.g., as determined by maximum detector 212). Thus, based on a polling rate of a measured temperature (e.g., which may be retrieved from a thermal table stored within or accessible to management controller 112, retrieved from temperature sensor 118, or retrieved or determined in any other suitable manner), and a maximum rate of change of such measured temperature between polling events, thermal control system 114 may read from lookup table 214 a corresponding PI controller gain to be applied to a response (e.g., PI driving signal) of a PI controller 208. Turning briefly to FIG. 3, FIG. 3 illustrates an example lookup table 214 for generating PI controller gain based on a polling rate and a temperature rate of change, in accordance with embodiments of the present disclosure. As shown in FIG. 3, lookup table 214 may include a plurality of entries 302, wherein each entry 302 sets forth a PI controller gain which is indexed by one of a plurality of polling rates 304 of a measured temperature and one of a plurality of rates of change 306 of the measured temperature between polling events of the measured temperature. Thus, based on the polling rate at which temperature is sampled from temperature sensor 118 and a maximum rate of change of such measured temperature between polling events as determined by maximum detector 212, thermal control system 114 may read from lookup table 214 an entry 302 corresponding to the polling rate and the maximum rate of change, such entry 302 having a PI controller gain to be applied to the response (e.g., PI driving signal) of PI controller 208.

Turning again to FIG. 2, threshold detector 216 may include any system, device, or apparatus configured to compare the differential error signal ΔERROR generated by differentiator 206 to a predetermined threshold differential error signal value, and output an enable signal indicative of such comparison. For example, if threshold detector 216 determines that the differential error signal ΔERROR exceeds the predetermined threshold, threshold detector 216 may deassert (e.g., set to “OFF,” “FALSE,” logic “0,” etc.) the enable signal and may assert (e.g., set to “ON,” “TRUE,” logic “1,” etc.) the enable signal otherwise (e.g., if the differential error signal ΔERROR is less than the predetermined threshold). In some embodiments, threshold detector 216 may apply a somewhat more detailed set of rules in determining whether to assert the enable signal. For example, in some of such embodiments, threshold detector 216 may assert the enable signal only if the differential error signal ΔERROR remains below the predetermined threshold for at least a predetermined minimum number of polling cycles of temperature sensor 118.

Multiplexer 218 may include any system, device, or apparatus configured to, when the enable signal is asserted by threshold detector 216, output a gain signal equivalent to the PI controller gain generated by lookup table 214, and otherwise (e.g., when the enable signal is deasserted by threshold detector 216), output a gain signal of zero.

Gain element 220 may apply the gain signal output by multiplexer 218 (e.g., the PI controller gain generated by lookup table 214 if the enable signal generated by threshold detector 216 is asserted, zero if the enable signal generated by threshold detector 216 is deasserted) to the PI output driving signal. The output of gain element 220 may comprise a power adjustment signal indicative of a power adjustment to be made to a component of information handling system 102 (e.g., processor 103) in order to cause, when appropriate, power capping or throttling of such component. In some embodiments, the power adjustment signal output by gain element 220 may be directly provided to a component having its power consumption controlled by thermal control system 114. In other embodiments, the power adjustment signal output by gain element 220 may be further processed by thermal control system 114 or management controller 112 to generate a control signal for controlling power consumption of the component.

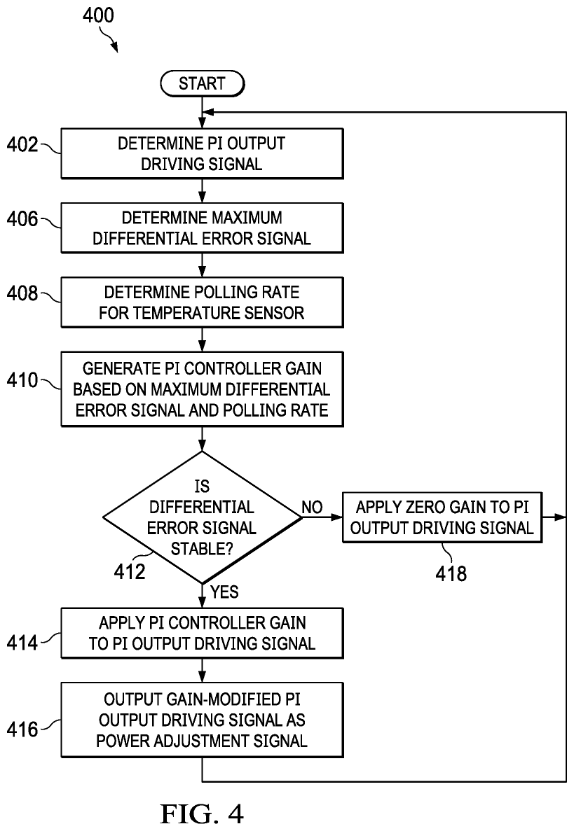

FIG. 4 illustrates a flow chart of an example method 400 for power capping based on component temperature margins, in accordance with embodiments of the present disclosure. According to one embodiment, method 400 may begin at step 402. As noted above, teachings of the present disclosure may be implemented in a variety of configurations of information handling system 102 and/or thermal control system 114. As such, the preferred initialization point for method 400 and the order of the steps comprising method 400 may depend on the implementation chosen.

At step 402, thermal control system 114 may determine a PI output driving signal based on a temperature error signal and an integrated error signal (e.g., by PI controller 208).

At step 406, thermal control system 114 may determine a maximum differential error signal based on previous samples of the differential error signal received over the period of time (e.g., by maximum detector 212). At step 408, thermal control system 114 may determine (e.g., receive or retrieve) a polling rate for a temperature sensor. At step 410, based on the maximum differential error signal and the polling rate, thermal control system 114 may generate a PI controller gain (e.g., by lookup table 214).

At step 412, thermal control system 114 may determine (e.g., by threshold detector 216) if the differential error signal is stable (e.g., is below a predetermined threshold value, or has been below a predetermined threshold value for a minimum period of time). If the differential error signal is stable, method 400 may proceed to step 414. Otherwise, method 400 may proceed to step 418.

At step 414, in response to the differential error signal being stable, thermal control system 114 may apply the PI controller gain to the PI output driving signal (e.g., by gain element 220). At step 416, thermal control system 114 may output a power adjustment signal equal to the gain-modified PI output driving signal. After completion of step 416, method 400 may proceed again to step 402.

At step 418, in response to the differential error signal being unstable, thermal control system 114 may apply a zero gain to the PI output driving signal. After completion of step 418, method 400 may proceed again to step 402.

Although FIG. 4 discloses a particular number of steps to be taken with respect to method 400, method 400 may be executed with greater or lesser steps than those depicted in FIG. 4. In addition, although FIG. 4 discloses a certain order of steps to be taken with respect to method 400, the steps comprising method 400 may be completed in any suitable order.

Method 400 may be implemented using information handling system 102, thermal control system 114, or any other system operable to implement method 400. In certain embodiments, method 400 may be implemented partially or fully in software and/or firmware embodied in computer-readable media.

Although the foregoing discussion contemplates application systems and methods for closed-loop control of operation of an air mover, similar methods and systems may be generalized and applied to other closed-loop controls. For example, such similar methods and systems may be applied to generate a driving signal to any appropriate plant or component based on any measured process value other than a measured temperature and a setpoint value other than a setpoint temperature.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A closed-loop control system comprising:
an integrator configured to, based on an error between a setpoint temperature and a measured temperature, determine an integrated error indicative of a time-based integral of the error;
a proportional-integral controller configured to, based on the integrated error and the error, generate a proportional-integral output driving signal; and
control logic configured to control power consumption of a component based on the proportional-integral output driving signal.

2. The closed-loop control system of claim 1, wherein the component is a processor.

3. The closed-loop control system of claim 1, wherein controlling power consumption of the component based on the proportional-integral output driving signal comprises capping power consumption of the component when the proportional-integral output driving signal indicates that the component is operating near the setpoint temperature.

4. A method comprising:
based on an error between a setpoint temperature and a measured temperature, determining an integrated error indicative of a time-based integral of the error;
based on the integrated error and the error, generating a proportional-integral output driving signal; and
controlling power consumption of a component based on the proportional-integral output driving signal.

5. The method of claim 4, wherein the component is a processor.

6. The method of claim 4, wherein controlling power consumption of the component based on the proportional-integral output driving signal comprises capping power consumption of the component when the proportional-integral output driving signal indicates that the component is operating near the setpoint temperature.

7. An information handling system comprising:
an information handling resource; and
a closed-loop thermal control system comprising:
an integrator configured to, based on an error between a setpoint temperature and a measured temperature, determine an integrated error indicative of a time-based integral of the error;
a proportional-integral controller configured to, based on the integrated error and the error, generate a proportional-integral output driving signal; and
control logic configured to control power consumption of the information handling resource based on the proportional-integral output driving signal.

8. The information handling system of claim 7, wherein the information handling resource is a processor.

9. The information handling system of claim 7, wherein controlling power consumption of the information handling resource based on the proportional-integral output driving signal comprises capping power consumption of the information handling resource when the proportional-integral output driving signal indicates that the information handling resource is operating near the setpoint temperature.

10. An article of manufacture comprising:
a non-transitory computer-readable medium; and
computer-executable instructions carried on the computer-readable medium, the instructions readable by a processor, the instructions, when read and executed, for causing the processor to:
based on an error between a setpoint temperature and a measured temperature, determine an integrated error indicative of a time-based integral of the error;
based on the integrated error and the error, generate a proportional-integral output driving signal; and
control power consumption of a component based on the proportional-integral output driving signal.

11. The article of claim 10, wherein the component is a second processor.

12. The article of claim 10, wherein controlling power consumption of the component based on the proportional-integral output driving signal comprises capping power consumption of the component when the proportional-integral output driving signal indicates that the component is operating near the setpoint temperature.
